(19) United States
(12) Patent Application Publication
(10) Pub. No.: US 2013/0180455 A1
(43) Pub. Date: Jul. 18, 2013

(54) CONTROL SYSTEM FOR AT LEAST ONE FLEXIBLE TUBULAR ELEMENT CONNECTED TO A CUP-SHAPED MEMBER

(71) Applicants: Nils-Erik Holmertz, Huddinge (SE); Sten Mellberg, Gustavsberg (SE)

(72) Inventors: Nils-Erik Holmertz, Huddinge (SE); Sten Mellberg, Gustavsberg (SE)

(73) Assignee: DELAVAL HOLDING AB, Tumba (SE)

(21) Appl. No.: 13/825,558

(22) PCT Filed: Oct. 24, 2011
(86) PCT No.: PCT/SE2011/051258

§ 371 Date: Mar. 22, 2013

Related U.S. Application Data
(60) Provisional application No. 61/406,635, filed on Oct. 26, 2010.

(30) Foreign Application Priority Data
Oct. 26, 2010 (SE) 1051111-1

(51) Int. Cl. A01J 5/01

(52) U.S. Cl. CPC A01J 5/0175
USPC 119/14.08

(57) ABSTRACT

A control system for at least one flexible tubular element connected to a cup-shaped member includes a positioning mechanism arranged to hold the cup-shaped member and the tubular element in a parking position in a magazine when the cup-shaped member is not used, and to allow a pull-out motion of the tubular element when the cup-shaped member is moved from the parking position in the magazine to an attaching position on a teat of an animal by a gripping member. The control system further includes a control unit arranged to control the positioning mechanism such that it provides a pull-out motion of the tubular element with a controlled speed when the cup-shaped member is moved from the parking position to the attaching position on a teat of an animal by the gripping member.

### BACKGROUND OF THE INVENTION AND PRIOR ART

The present invention relates to a control system for at least one flexible tubular element connected to a cup-shaped member, wherein the control system comprises a positioning mechanism arranged to hold the cup-shaped member and the tubular element in a parking position in a magazine when the cup-shaped member is not used, and to allow a pull-out motion of the tubular element when the cup-shaped member is moved from the parking position to an attaching position on a teat of an animal by means of a gripping member.

Teat cups are usually provided with a milk tube and a pulse tube. In an automatic milking system, the teat cups are attached to the teats of a cow by means of a robot arm. The robot arm grips the teat cups in a teat cup magazine by means of a gripper and moves them to a respective teat of the cow. During this motion, the milk tubes and the pulse tubes of the respective teat cups are pulled out from the teat cup magazine against the action of a resistance force. The resistance force may be created by air flowing through a narrow opening in a removing cylinder in the teat cup magazine. Due to for example wear, the active cross section area of the narrow opening, and thus the value of said resistance force, may change with the time during operation of the removing cylinder. In case the tubes are pulled out against the action of a very low resistance force, the release length of the tubes risk being so long that the tubes come in contact with a floor surface in a milking stall when the gripper moves the teat cup towards a teat of a cow. If the tubes come in contact with the floor surface in the vicinity of a leg of the cow, there is a risk that the cow steps on or kicks on the tubes. In this case, the teat cup risks coming loose from the gripper. In case the tubes are pulled out against the action of a very high resistance force, the pulling force acting between the gripper and the teat cup may be so high that the teat cup may come loose from the gripper when the gripper moves the teat cup towards a teat of a cow.

### SUMMARY OF THE INVENTION

The object of the present invention is to provide a control system ensuring that the tubular elements is always pulled out in a desired manner when the teat cup is moved from a teat cup magazine to an attaching position on a teat of an animal.

This object is obtained by the control system initially defined, which is characterized in that the control system comprises a control unit arranged to control the positioning mechanism such that it provides a pull-out motion of the tubular element with a controlled speed when the cup-shaped member is moved from the parking position in the magazine to the attaching position on a teat of an animal by means of the gripping member. It is desired that the tubular element is pulled out with a suitable speed in relation to the speed of the gripping member. In case the tubular element is pulled out with a too low speed, the motion of the gripping member is broken and a pulling force arises in the cup-shaped member and the tubular element. If this pulling force is large enough, the cup-shaped member risks coming loose from the gripping member. In case the tubular element is pulled out with a too high speed, the release length of the tubular element will be unnecessarily long. If the release length is too long, there is a risk that the animal will stamp on or kick on the tubular element. Also in this case, the cup-shaped member risks coming loose from the gripping member. The control unit may be a computer unit or the like comprising a suitable software for the above mentioned control of the pull-out speed of the tubular element. The control unit may be able to estimate a suitable constant pull-out speed of the tubular element or a suitable varying pull-out speed of the tubular element, and to control the positioning mechanism such that the tubular element is pulled out with the estimated speed.

According to an embodiment of the invention, the control system comprises a sensor adapted to sense a parameter related to the pull-out motion of the tubular element, and is arranged to estimate a suitable pull-out speed of the tubular element by means of information about said parameter. The control unit is here able to change the speed of the pull-out motion of the tubular member in view of received parameter values. The sensor may for example be arranged to sense a parameter related to the pulling force in the tubular element during the pull-out motion of the tubular element. In case the pulling force in the tubular element exceeds a maximum acceptable value, the control unit notes that the release length of the tubular element is too short, and increases the pull-out speed of the tubular element. In case the pulling force in the tubular element is below a minimum acceptable value, the control unit notes that the release length of the tubular element is too long, and decreases the pull-out speed of the tubular element.

According to an embodiment of the invention, the cup-shaped member is arranged to be moved from the parking position in the magazine to the attaching position on a teat of an animal by means of a gripping member in the form of a gripper of a robot arm. In an automatic milking system, it is favorable to use a robot arm for attaching the cup-shaped member to the teats of a milking animal. Alternatively, the cup-shaped member is manually attached to the teats by means of an operator. The gripping member is here a hand of the operator. In case a robot arm is used, the control unit may be arranged to estimate a suitable pull-out speed of the tubular element by means of stored information about the robot arm used. Generally, a robot arm moves the gripper with the cup-shaped member towards a teat of a milking animal along a substantially predetermined path and with a predetermined speed. By means of such information, it is possible for the control unit to estimate a suitable pull-out speed of the tubular element in advance. The control unit may here receive information indicating when the robot arm starts the motion of the cup-shaped member. This information makes it possible for the positioning mechanism to start the pull-out motion of the tubular element simultaneously or somewhat before the cup-shaped member is moved from the parking position in the magazine. The control unit may receive this information from a control system of the robot arm, or from a sensor indicating when the cup-shaped member leaves the parking position in the magazine,

According to an embodiment of the invention, the control unit is arranged to estimate a suitable pull-out speed of the tubular element by means of information about the position coordinates of the gripper when it moves the cup-shaped member from the parking position to the attaching position. Preferably, the control unit substantially continuously receives information about the actual position coordinates of the gripper of the robot arm. The control unit may calculate, by means of this information, the actual speed and the direction of motion of the gripper and the cup-shaped member in relation to the parking position in the magazine. The control unit may estimate a pull-out speed of the tubular element such that the release length of the tubular element will always be longer than the rectilinear distance between the cup-shaped member and its parking position in the magazine. In this case, the estimated pull-out speed may be equally to or somewhat higher than the speed of the gripper when it moves the cup-shaped member from the magazine to an attaching position on a teat.

According to an embodiment of the invention, the control unit is arranged to estimate a pull-out speed of the tubular element resulting in a lowest part of the tubular element always being located at least at a level located at a minimum height above a floor surface on which the animal stands. Such a lowest acceptable level may for example be 10 centimeters above the floor surface. In this case, the control unit estimates a pull-out speed of the tubular element at which the lowest part of the tubular element will always be located at this lowest acceptable level or at a higher level above the floor surface. Thereby, the risk that the animal steps on the tubular element or kicks on it such that the cup-shaped member comes loose from the gripper is substantially eliminated.

According to an embodiment of the invention, the control unit is arranged to estimate a pull-out speed of the tubular element resulting in a lowest part of the tubular element always being located at a level located at least at a minimum distance below the level of the cup-shaped member when the cup-shaped member is to be attached to a teat. Said minimum distance may, for example, be 10 centimeters. In this case, the control unit estimates a pull-out speed of the tubular element at which the lowest part of the tubular element will always be located at this minimum distance or at a greater distance below the level of the cup shaped member when the cup-shaped member is to be attached to the teat. Thereby, the tubular element hangs downwards from the cup-shaped member with an angle such that the tubular element does not exert a lateral force on the cup-shaped member.

According to an embodiment of the invention, the positioning mechanism may comprise a stationarily arranged guiding element in the magazine, a movably arranged guiding element of the tubular element, and a drive arrangement able to displace the movable guiding element with a variable speed in relation to the stationary guiding element. By means of such guiding elements it is very easy to control the pull-out speed of the tubular element in a variable manner. At least the movable guiding element may comprise a rolling member adapted to support an upper curved part of the tubular element. Thereby, it is possible to pull out the tubular element with a relatively small force.

According to an embodiment of the invention, the drive arrangement comprises a motor and a transmission adapted to displace the movable guiding element along a path in relation to the stationary guiding element. Preferably, the motor is an electric motor. An electric motor is easy to activate and to control. However, it is also possible to use other kinds of motors. The transmission may comprise gear wheels adapted to displace the movable guiding element along a path formed by gear rods. By means of such a transmission it is possible to displace the movable guiding element with a variable speed in relation to the stationary guiding element. Alternatively, the transmission comprises a rotatable rod element, wherein the rod element and the guiding element is connected to each other by means of helical connecting elements such that a rotary motion of the rod element is transmitted to a movement of the guiding element along a path in an axial direction of the rod element. The rod element may be arranged in a through hole of the guiding element. The rod element may comprise a helical groove around its periphery surface or helical threads to be engaged with a suitable helical conting element in the through hole of the guiding element. When the rod element is rotated, the guiding element is displaced in an axial direction of the rod element.

According to an embodiment of the invention, the control unit is adapted to receive information from a sensor when the cup-shaped member is to be removed from the teat, and to activate the positioning mechanism such that it retracts the cup-shaped member from the attaching position on the teat to the parking position in the magazine. In this case, the positioning mechanism is also used to detach the cup-shaped member from the teat and move it back to the magazine. Thus, no separate removing device (usually in the form of a vacuum cylinder) needs to be used in the magazine.

According to an embodiment of the invention, the cup-shaped member is a teat cup attached to a teat during a milking process. Tubular elements in the form of a milk tube and a pulse tube are connected to the teat cup. Alternatively, the cup-shaped member is a teat cleaning cup attached to the teat during a cleaning process of the teat. A cup is many times used for cleaning the teats before a milking process is started. The connected tubular element may here be adapted to supply a cleaning liquid to the teat and to discharge the cleaning liquid from the teat cleaning cup.

### BRIEF DESCRIPTION OF THE DRAWINGS

In the following, preferred embodiments of the invention are described by means of an example and with references to the attached drawings, in which:

FIG. 1 shows a control system for teat cups in a teat cup magazine according to a first embodiment of the invention,

FIG. 2 shows a control system according to a further embodiment of the invention and

FIG. 3 shows an embodiment of a positioning mechanism used in the teat cup magazine,

FIG. 4 shows an alternative embodiment of the positioning mechanism and

FIG. 5 shows a view of the positioning mechanism in FIG. 4 in the plane A-A.

### BRIEF DESCRIPTION OF PREFERRED EMBODIMENTS OF THE INVENTION

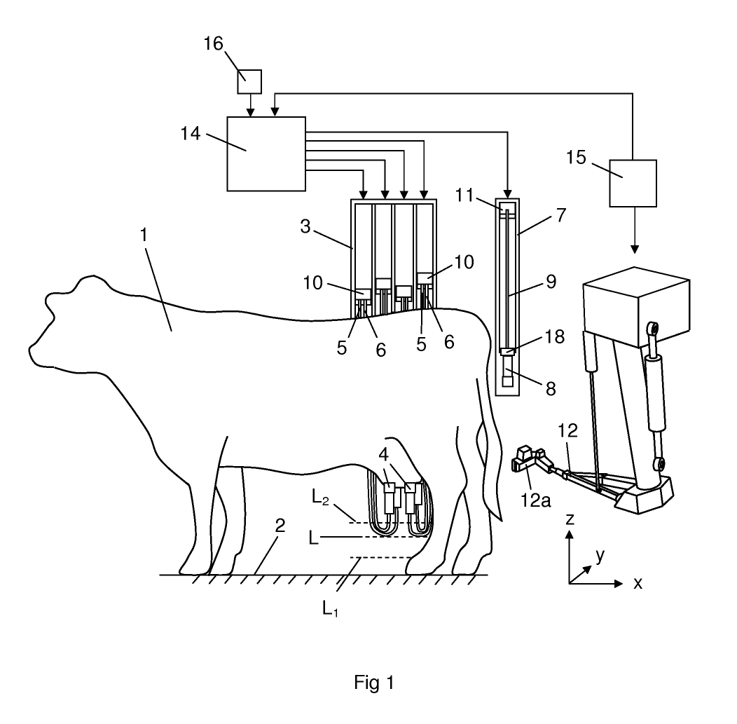

FIG. 1 shows a cow 1 standing on a floor surface 2 in a milking stall. The milking stall comprises a teat cup magazine 3 with four teat cups 4. Each teat cup 4 is connected to a milk tube 5 and a pulse tube 6. The milking stall also comprises a teat cleaning cup magazine 7 with a teat cleaning cup 8. The teat cleaning cup 8 is connected to a tubular element 9. The teat cups 4 and the teat cleaning cup 8 are attached to the teats of the cow 1 by means of a gripper 12a of a robot arm 12. Before a milking process is started in the milking stall, the teats of the cow 1 have to be cleaned. The gripper 12a of the robot arm 12 fetches the teat cleaning cup 8 from a parking position in the teat cleaning cup magazine 7 and moves it to the respective teats of the cow 1 in proper order. When the cleaning process of the teats is ready, the teat cleaning cup 8 is retracted to its parking position in the teat cleaning cup magazine 7 by means of a positioning mechanism. Thereafter, the gripper 12a of the robot arm 12 fetches the teat cups 4 from their respective parking positions in the teat cup magazine 3 and attaches them to the teats of the cow 1. The milking process starts as soon as all teat cups 4 have been attached to the teats of the cow 1. When the milking process is finished, the teat cups 4 are individually retracted to the parking positions in the teat cup magazine 3 by means of a respective positioning mechanism.

Thus, the teat cup magazine 3 comprises a positioning mechanism for each teat cup 4. Each positioning mechanism comprises a movably arranged guiding element 10 adapted to guide an upper curved end position of the milk tube 5 and the pulse tube 6 in the teat cup magazine 3. The guiding element 10 is displaceable in a vertical direction in the teat cup magazine 3. The release length of the milk tube 5 and the pulse tube 6 is defined by the vertical position of the guiding element 10. The pull-out speed of the milk tube 5 and the pulse tube 6 is defined by the vertical speed of the guiding element 10. Each positioning mechanism has a construction allowing a pull-out motion of a teat cup 4 and the connected milk tube 5 and pulse tube 6 from the parking position in the magazine 3 to an attaching position on a teat of the cow 1.

The teat cleaning cup magazine 7 comprises a corresponding positioning mechanism for the teat cleaning cup 8. This positioning mechanism comprises a movably arranged guiding element 11 adapted to define an upper curved end position of the tubular element 9 in the magazine 7. The guiding element 11 is displaceable in a vertical direction in the teat cleaning cup magazine 7. A stationarily arranged guiding element 18 defines the parking position of the teat cleaning cup 8 in the magazine 7. FIG. 1 shows the teat cleaning cup 8 and the connected tubular element 9 in a parking position in the magazine 7. The release length of the tubular element 9 is defined by the vertical position of the guiding element 11 and the pull-out speed of the tubular element 9 is defined by the vertical speed downwards of the guiding element 11.

It is important that the tubes 5, 6 are pulled out with a suitable speed in relation to the speed of the gripping member 12a of the robot arm 12 when the teat cups 4 are moved from the teat cup magazine 3 to an attachment position on a respective teat of the cow. In case the positioning mechanism releases the tubes with a lower speed than the speed of the gripper 12a, the motion of the gripper 12a is broken resulting in a pulling force in the tubes 5, 6. If this pulling force is large enough, the teat cup 4 risks coming loose from the gripper 12a. In case the positioning mechanism releases the tubes 5, 6 with a much higher speed than the speed of the gripper 12a, the release length of the tubes will be unnecessarily long. If the release length is too long, there is a risk that the cow 1 will stamp on or kick on the tubes 5, 6. Also in this case, the teat cup 4 risks coming loose from the gripper 12a.

The milking stall comprises a control system for controlling the pull-out speed of the tubes 5, 6 when the teat cups 4 are moved from the teat cup magazine 3 to an attaching position on a respective teat of a cow 1 in the milking stall. The control system comprises a control unit 14 able to estimate a pull-out speed of the tubes 5, 6 and a positioning mechanism arranged to pull out the tubes 5, 6 with the estimated pull-out speed. The control unit 14 may be a computer unit or the like comprising a suitable software for estimating a suitable pull-out speed of the tubes 5, 6 and for controlling the positioning mechanism such that it pulls out the tubes 5, 6 with the estimated pull-out speed.

When the teat cups 4 are to be attached to a cow 1 in the milking stall, a second control system 15 controlling the robot arm 12 is activated. The robot arm 12 moves the gripper 12a to the teat cup magazine 3 where it grips a teat cup 4. The control unit 14 substantially continuously receives information about the position coordinates x, y, z of the gripper 12a of the robot arm 12 from the second control system. The position coordinates x, y, z of the gripper 12a define the teat cup 4 that is be gripped by the gripper 12a, and the control unit 14 activates the positioning mechanism for this teat cup 4. The positioning mechanism moves the movable guiding element 10 downwards such that the tubes 5, 6 obtain an initial pull-out motion. The initial pull-out motion of the tubes 5, 6 is performed simultaneously or somewhat before the gripper 12a moves the teat cup 4 from its parking position in the teat cup magazine 15. By means of said information about the position coordinates x, y, z of the gripper 12a, the control unit 14 estimates a suitable pull-out speed of the tubes 5, 6. The control unit 14 controls the positioning mechanism such that the guiding element 10 is moved downwards with a speed resulting in the estimated pull-out speed of the tubes 5, 6. The estimates pull-out speed of the tubes 5, 6 corresponds at least to the speed of the teat cup given by the robot arm 12.

The control unit 14 substantially continuously estimates, by information about the position coordinates x, y, z of the gripper 12a, new pull-out speeds of the tubes 5, 6 during the whole motion of the teat cup 4 from the teat cup magazine 3 to an attaching position on a teat of the cow 1. The control unit 14 estimates pull-out speeds of the tubes 5, 6 such that the release length of the tubes 5, 6 is always somewhat longer than the rectilinear distance between the teat cup 4 and its parking position in the teat cup magazine 3. By means of such a controlled pull-out speed of the tubes 5, 6, there is no risk that the release length of the tubes 5, 6 will be so short that a pulling force arises releasing the teat cup 4 from the gripper 12a.

The control unit 14 is further arranged to estimate a pull-out speed of the tubes resulting in a lowest part of the tubes 5, 6 always being located at least at a level located at a minimum height above a floor surface 2 in the milking stall. Such a lowest acceptable level L₁ may for example be 10 centimeters above the floor surface 2. Thereby, the risk that the cow 1 steps on the tubular element or kicks on it such that the teat cup 4 comes loose from the gripper 12a during the attaching process is substantially eliminated. Furthermore, the control unit 14 is arranged to estimate a pull-out speed of the tubes 5, 5 resulting in a lowest part of the tubes always being located at a level located at least at a minimum distance below the level of the cup 4 when the teat cup 4 is to be attached to a teat. Said minimum distance may, for example, be 10 centimeters. Thereby, the tubes 5, 6 hang downwards from the teat cup 4 with an angle such that the tubes 5, 6 do not exert a lateral force on the teat cup when it is attached to the teat of the cow 1.

When the robot arm 12 has attached all teat cups 4 to a respective teat of the cow 1, the milking process is started. If, for example, the cow moves during the milking process, the positioning mechanism may adjust the release length of the tubes 5, 6 such that the lowest part of the tubes 5, 6 is always located at a level L between the above mentioned levels L₁, L₂. A milk meter 15 measures the milk flow in each milk tube 5 of the teat cups 4 during the milking process. When the milk flow in a milk tube 5 drops below a predetermined value, the milking process is finished. The control unit 14 activates the positioning mechanism such that it displaces the guiding element 10 to an upper end position in the teat cup magazine 3. Thereby, the teat cup 4 will be detached from the teat and moved to the parking position in the magazine 3.

The teats of the cow 1 have to be cleaned before the start of the milking process. The positioning mechanism of the teat cleaning cup magazine 7 is arranged to control the pull-out speed of the tubular element 9 in the same way as the positioning mechanisms in the teat cup magazine 3 control the pull-out speeds of the tubes 5, 6.

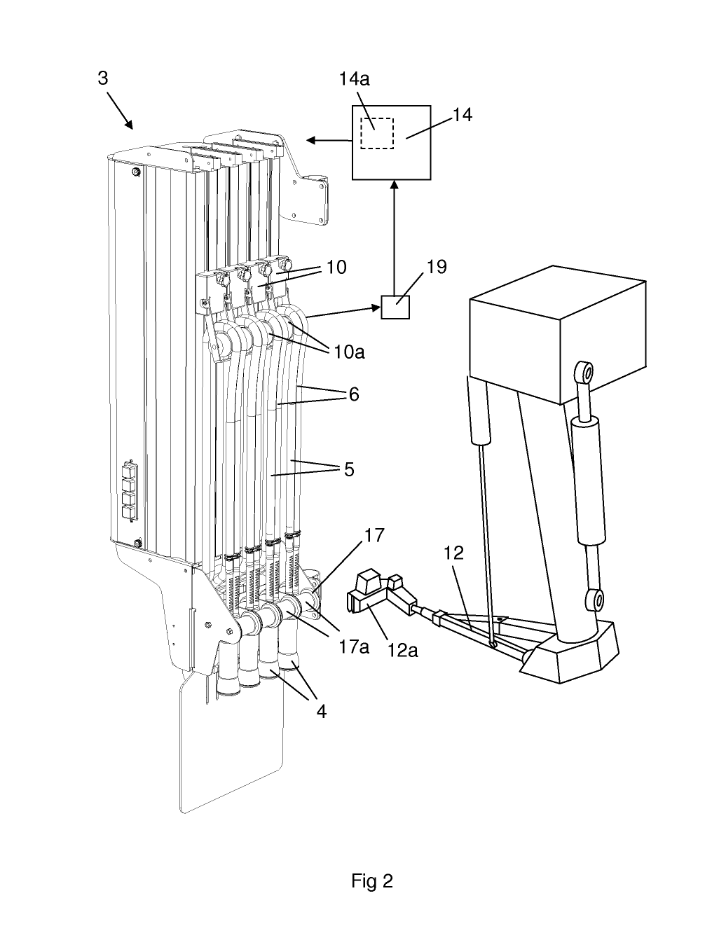

FIG. 2 shows a teat cup magazine 3 in more detail. Each positioning mechanism in the teat cup magazine 3 comprises a stationarily arranged guiding element 17 defining a parking position of a teat cup 4. The stationary guiding element 17 comprises a rolling member 17a. The parking positions of the teat cups 4 are located in a row at a lower end portion of the teat cup magazine 3. The movably arranged guiding element 10 of the milk tube 5 and the pulse tube 6 also comprises a rolling member 10a. The milk tube 5 and the pulse tube 6 extend upwards from a lower part of the magazine 3 to the rolling member 10a of the movably arranged guiding element 10. The rolling member 10a defines the highest position of the milk tube 5 and the pulse tube 6 in the teat cup magazine 3. The milk tube 5 and the pulse tube 6 extend downwards from the rolling member 10a to the rolling member 17a of the stationary guiding element in the magazine 3. When a movable guiding element 10 is located in an upper end position in the magazine 3, the teat cup 4 is in a parking position. When the movable guiding element 10 is displaced to a lower position in the magazine 3, the milk tube 5 and the pulse tube 6 of the teat cup 4 are released to a length corresponding to the vertical position of the movable guiding element 10.

In this example, the control unit 14 contains stored information 14a about the robot arm 12 used. The robot arm 12 moves the gripper 12a along a substantially predetermined path and with a predetermined speed when it fetches a teat cup in a teat cup magazine 3 and moves it to a teat of a cow 1 in a milking stall. It is possible for the control unit 14 to estimate a suitable pull-out speed of the tubes 5, 6 in view this stored information with a good accuracy. The control unit 14 may here receive information indicating when the robot arm 12 starts the motion of the teat cup 4. This information makes it possible for the positioning mechanism to start the pull-out motion of the tubes 5, 6 at the right time. The control unit 14 may receive this information from the second control system 15. Alternatively, the control unit may receive information from an indicating sensor which indicates when the teat cup 4 leaves the parking position in the teat cup magazine 3.

According to a further alternative, a pressure sensor 19 may be used to sense a pressure acting on the rolling member 10a of the movable guiding element 10. When the gripper 12a of the robot arm 12 has gripped a teat cup 4 in the teat cup magazine 3, it applies a pulling force on the teat cup 4 when it intends to move the teat cup 4 from the parking position. This pulling force is transmitted, via the tubes 5, 6, to a pressure acting on the rolling member 10a. The control unit 14 receives information from the pressure sensor 19 about the value of the pressure and estimates a suitable pull-out speed of the tubes 5, 6 by means of this information. The control unit 14 then controls the positioning mechanism such that the movable element 10 is moved downwards with a speed corresponding to the estimated pull-out speed of the tubes 5, 6. The control unit 14 may substantially continuously receive signals from the pressure sensor about sensed pressure values. If the pressure values exceed a maximum acceptable pressure value, the control unit may control the positioning mechanism such that it increases the pull-out speed of the tubes 5, 6. If the pressure values drop below a minimum acceptable pressure value, the control unit may control the positioning mechanism such that it decreases the pull-out speed of the tubes 5, 6.

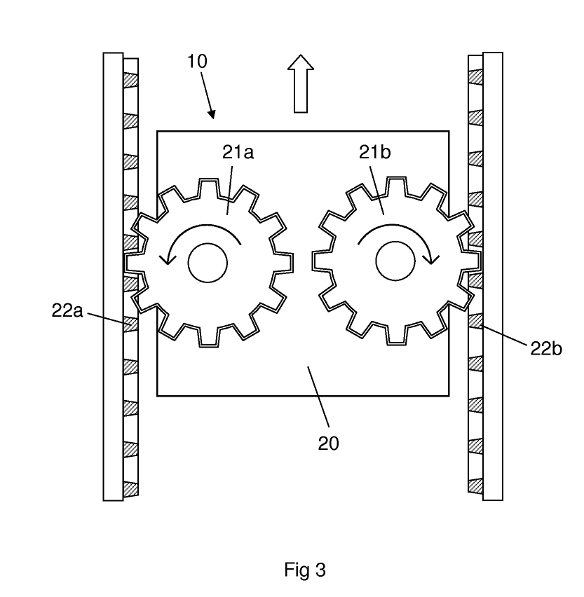

FIG. 3 shows a cross section view of one of the movably arranged guiding elements 10 in the teat cup magazine 3. The movably arranged guiding element 10 comprises an electric motor 20 and a transmission comprising two gear wheels 21a, 21b. The transmission has a design such that it transforms a linear motion from a shaft of the electric motor to rotary motions of the two gear wheels 21a, 21b. The gear wheels 21a, 21b rotate with the same speed but in opposite directions. The gear wheels 21a, 21b are engaged with a respective gear rod 22a, 22b each having a vertical extension in the magazine 3. The electric motor 20 is controlled by the control unit 14. In this case, the electric motor 20 moves the gear wheels 21a, 21b such that the movably arranged element 10 is displaced upwards or downwards in the magazine 3. In this case, it is possible to alter the distance between the movable guiding element 10 and the stationary guiding element 17 in a stepless manner. It is thereby also possible to adjust the release length of the tubes 5, 6 and the pull-out speed of the tubes 5, 6 in a stepless manner.

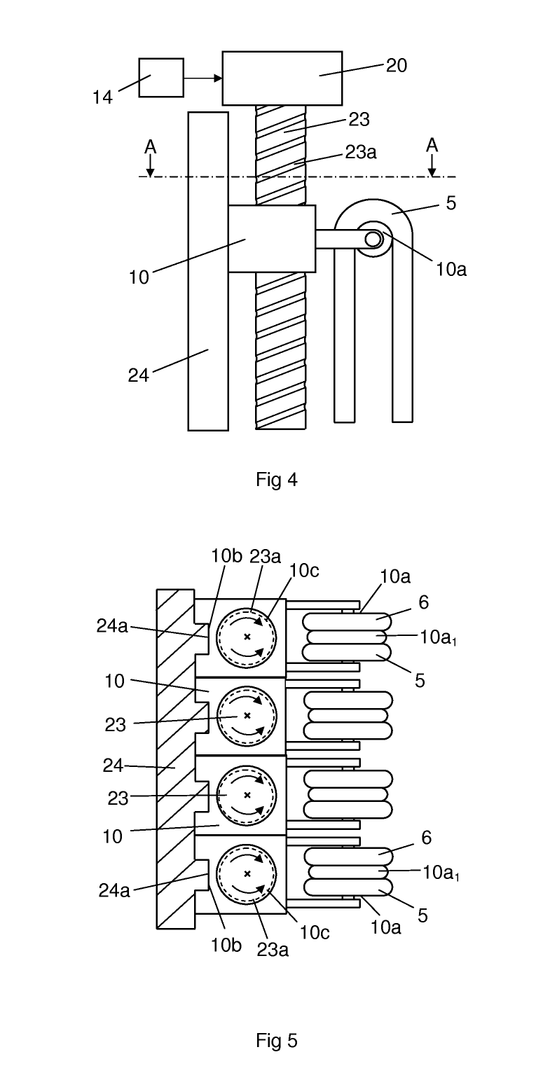

FIGS. 4 and 5 shows an alternative positioning mechanism in a teat cup magazine 3. The positioning mechanism comprises a movably arranged guiding element 10 for the milk tube 5 and the pulse tube 6 of each teat cup in the teat cup magazine 3. Each guiding element 10 is provided with a rolling member 10a supporting the milk tube 5 and the pulse tube 6 in a highest position in the teat cup magazine. Each rolling member 10a comprises a distance member 10a₁ arranged between the milk tube 5 and the pulse tube 6. The guiding element 10 comprises a through hole. An elongated rod element 23 extends through the through hole. The rod element 23 is provided with a helical groove around its peripheral surface, The guiding element 10 comprises a helical connecting element 10c in the through hole. The helical connecting element 10c may be a helical thread, balls or the like to be engaged into the helical groove of the rod element 23. Each rod element 23 is rotatably arranged by means of an electric motor 20 or the like. The electric motor may be arranged at an upper or lower end portion of the rod element 23. The electric motor 20 is able to rotate the rod element 23 with different speeds in two opposite directions. The rotary motion of the electric motor 20 and the rod element is controlled by the control unit 14.

Each guiding element 10 comprises a recess 10b receiving a protruding vertical portion 24a of a vertical support element 24. The vertical portion 24a prevents rotary motions of the guiding element 10 such that the guiding element 10 is only able to move upwards and downwards in a vertical direction. When the electric motors 20 rotates the rod element 23 in one direction, the guiding element 10 is displaced upwards in the magazine 3 by means of the engagement between the helical connecting element 10c of the guiding element 10 and the helical groove 23a in the rod element 23. The guiding element 10 is displaced upwards with a speed related to rotary speed of the rod element 23 and the electric motor 20. When the electric motor 20 rotates the rod element 23 in an opposite direction, the guiding element 10 is displaced downwards with a speed related to rotary speed of the the rod element 23. Thus, it is possible to alter the distance between the movable guiding element 10 and the stationary guiding element 17 in a stepless manner. It is thereby also possible to adjust the release length of the tubes 5, 6 and the pull-out speed of the tubes 5, 6 in a stepless manner. The guiding element 10 may be manufactured by Teflon or a similar material such that the friction between the guiding element 10 and the rod element 23 will be low.

The invention is not limited to the described embodiments but may be varied and modified freely within the scope of the claims. The invention may of course be used in any kind of milking parlour, including rotary milking parlours. Any type of robot arm may of course be used. The robot arm may grip one or several teat cups at a time—if several teat cups are moved simultaneously, the pull-out speeds of all these teat cups should of course be controlled. It is not necessary to control the pull out speed also of the teat cleaning cup.

1-16. (canceled)

17. A control system for controlling a tubular element positioning mechanism, comprising:
a control unit (14); and
a magazine (3, 7) comprising a positioning mechanism,
the positioning mechanism controlled by the control unit (14),
the positioning mechanism holding a flexible tubular element (5, 6, 9) connected to a cup-shaped member (4, 8),
the positioning mechanism holding the tubular element (5, 6, 9) and the cup-shaped member (4, 8) in a parking position in the magazine (3, 7) when the cup-shaped member (4, 8) is not used,
the cup-shaped member (4, 8) being movable from the parking position to an attaching position on a teat of an animal (1) by a gripping member (12a),
the positioning mechanism providing, under control of the control unit, a pull-out motion of the tubular element (5, 6, 9) when the cup-shaped member (4, 8) is moved, by the gripping member (12a), from the parking position to the attaching position on a teat of an animal (1),
wherein, when the gripping member (12a) moves the cup-shaped member (4, 8) from the parking position to the attaching position on the teat of the animal (1), the control unit (14) controls the positioning mechanism to provide the pull-out motion of the tubular element (5, 6, 9) with a controlled speed.

18. The control system according to claim 17, wherein,
the control system further comprises a sensor (19) sensing information of a parameter related to the pull-out motion of the tubular element (5, 6, 9) and
the control unit (14), when controlling the positioning mechanism to provide the pull-out motion of the tubular element (5, 6, 9) with the pull-out speed, estimates the pull-out speed using the information of said parameter.

19. The control system according to claim 17, wherein the gripping member is a gripper (12a) of a robot arm (12).

20. The control system according to claim 19, wherein,
the control unit (14), when controlling the positioning mechanism to provide the pull-out motion of the tubular element (5, 6, 9) with the pull-out speed, estimates the pull-out speed using stored information (14a) about the robot arm (12).

21. The control system according to claim 19, wherein,
the control unit (14), when controlling the positioning mechanism to provide the pull-out motion of the tubular element (5, 6, 9) with the pull-out speed, estimates the pull-out speed using information about position coordinates (x, y, z) of the gripper (12a) as the gripper (12a) moves the cup-shaped member (4, 8) from the parking position to the attaching position.

22. The control system according to claim 21, wherein,
the control unit (14), when controlling the positioning mechanism to provide the pull-out motion of the tubular element (5, 6, 9) with the pull-out speed, estimates the pull-out speed such that a release length of the tubular element (5, 6, 9) is always longer than a rectilinear distance between the cup-shaped member (4, 8) and the parking position in the magazine (3, 7).

23. The control system according to claim 21, wherein,
the control unit (14), when controlling the positioning mechanism to provide the pull-out motion of the tubular element (5, 6, 9) with the pull-out speed, estimates the pull-out speed such that a lowest part of the tubular element (5, 6, 9) is always located at least at a minimum level (L1) above a floor surface on which the animal stands.

24. The control system according to claim 22, wherein,
the control unit (14), when controlling the positioning mechanism to provide the pull-out motion of the tubular element (5, 6, 9) with the pull-out speed, estimates the pull-out speed such that a lowest part of the tubular element (5, 6, 9) is always located at least at a minimum level (L1) above a floor surface on which the animal stands.

25. The control system according to claim 23, wherein,
the control unit (14), when controlling the positioning mechanism to provide the pull-out motion of the tubular element (5, 6, 9) with the pull-out speed, estimates the pull-out speed such that the lowest part of the tubular element (5, 6, 9) is always located at a level located at least at a minimum distance (L2) below a level of the cup-shaped member (4, 8) when the cup-shaped member (4, 8) has reached the attaching position at the teat.

26. The control system according to claim 17, wherein, the positioning mechanism comprises
i) a stationarily arranged guiding element (17, 18) in the magazine (3, 7),
ii) a movable guiding element (10, 11) of the tubular element (5, 6, 9) movably arranged in the magazine, and
iii) a drive arrangement, controlled by the control unit (14), to displace the movable guiding element (10, 11) within the magazine with a variable speed in relation to the stationary guiding element (17, 18).

27. The control system according to claim 26, wherein the movable guiding element (10, 11) comprises a rolling member (10a) defining a position of an upper part of the tubular element (5, 6, 9) in the magazine (3, 7).

28. The control system according to claim 25, wherein the drive arrangement comprises a motor (20) and a transmission (21a, 21b, 22a, 22b, 23) adapted to displace the movable guiding element (10, 11) along a path in relation to the stationary guiding element (17, 18).

29. The control system according to claim 28, wherein,
the transmission comprises gear wheels (21a, 21b) adapted to displace the movable guiding element (10, 11), and
the path along which the movable guiding element (10, 11) is displaced is formed by gear rods (22a, 22b).

30. The control system according to claim 28, wherein,
the transmission comprises a rotatable rod element (23), and
the rod element (23) and the guiding element (10, 11) are connected to each other by helical connecting elements (10c, 23a) such that a rotary motion of the rod element (23) causes a movement of the guiding element (10) along a path in an axial direction of the rod element (23).

31. The control system according to claim 17,
further comprising a sensor (16) connected to detect the cup-shaped member (4, 8) being removed from the teat, wherein,
the control unit (14) is connected to receive information from the sensor (16) connected to detect the cup-shaped member (4, 8) being removed from the teat, and
the control unit (14), when receiving the information that the cup-shaped member (4, 8) being removed from the teat, activates the positioning mechanism such that the positioning mechanism retracts the cup-shaped member (4, 8) from the attaching position on the teat to the parking position in the magazine (3, 7).

32. The control system according to claim 17, wherein the cup-shaped member is a teat cup (4) and the tubular element (5, 6) is one of a milk tube and a pulse tube.

33. The control system according to claim 17, wherein the cup-shaped member is a teat cleaning cup (8).
